(19) United States
(12) Patent Application Publication
(10) Pub. No.: US 2012/0016602 A1
(43) Pub. Date: Jan. 19, 2012

(54) METHOD AND DEVICE FOR DETERMINING THE PRESSURE UPSTREAM FROM THE TURBINE OF A SUPERCHARGING TURBOCHARGER OF A THERMAL ENGINE

(75) Inventors: Laurent Fontvieille, Gif Sur Yvette (FR); Nicolas D'Angelo, Comines (FR)

(73) Assignee: RENAULT SAS, Boulogne Billancourt (FR)

(21) Appl. No.: 13/145,872

(22) PCT Filed: Dec. 14, 2009
(86) PCT No.: PCT/FR2009/052524

§ 371 Date: Sep. 22, 2011

(30) Foreign Application Priority Data
Jan. 22, 2009 (FR) 0950396

(51) Int. Cl. G01L 3/24; G06F 19/00

(52) U.S. Cl. 702/44

(57) ABSTRACT

A method for determining, in a turbocharger for supercharging a thermal engine including a turbine and a compressor, the pressure upstream from the turbine based on the inlet air flow, the pressure upstream from the compressor, the temperature upstream from the compressor, the pressure downstream from the compressor, the temperature upstream from the turbine, and the pressure downstream from the turbine.

The present invention relates to a method for determining the pressure upstream of a turbine of a turbocharger used to supercharge a combustion engine.

In the field of pressure measurement it is generally known practice to use a sensor, for example of the piezoelectric type, that measures a variation in pressure.

However, such sensors are costly to fit.

The present invention proposes to replace a pressure sensor with an estimator.

One subject of the invention is a method for determining, for a turbocharger that supercharges a combustion engine comprising a turbine driven by the exhaust gases exiting said combustion engine and mechanically rotating as one with a compressor so as to compress the intake air injected into the combustion engine, the pressure upstream of the turbine as a function of the flow rate of intake air through the compressor, of the pressure upstream of the compressor, of the temperature upstream of the compressor, of the pressure downstream of the compressor, of the temperature upstream of the turbine and of the pressure downstream of the turbine.

Further features, details and advantages of the invention will become more clearly apparent from the detailed description given hereinafter by way of indication and in relation with drawings in which:

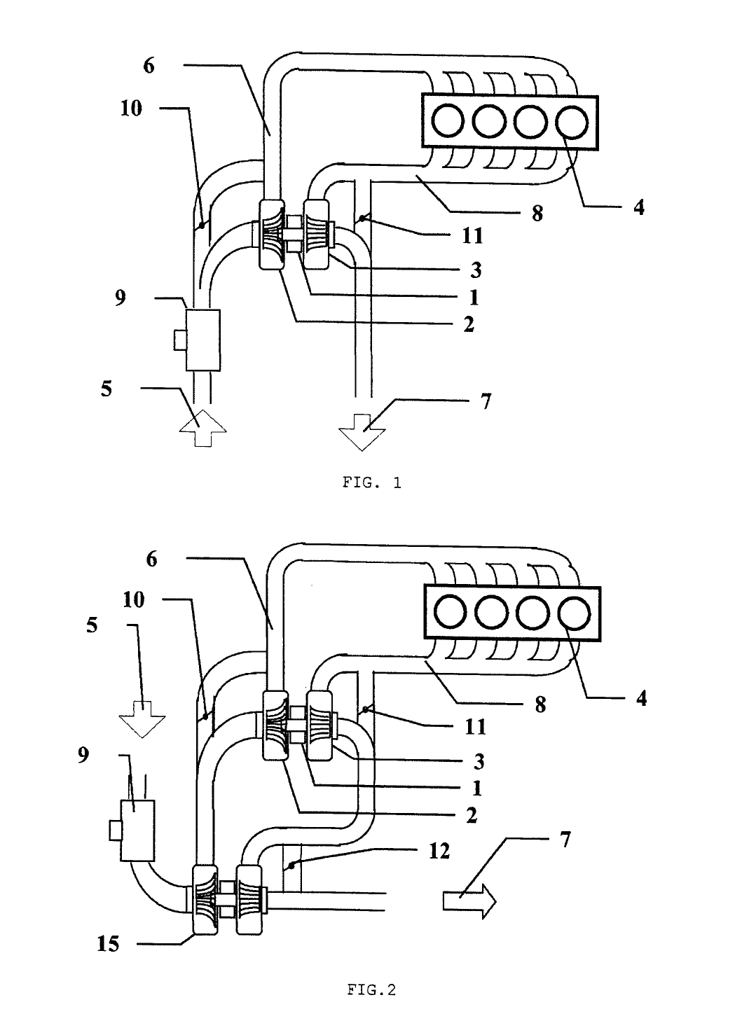

FIG. 1 illustrates a combustion engine with a supercharging turbocharger,

FIG. 2 illustrates a combustion engine equipped with a supercharging device comprising two turbochargers,

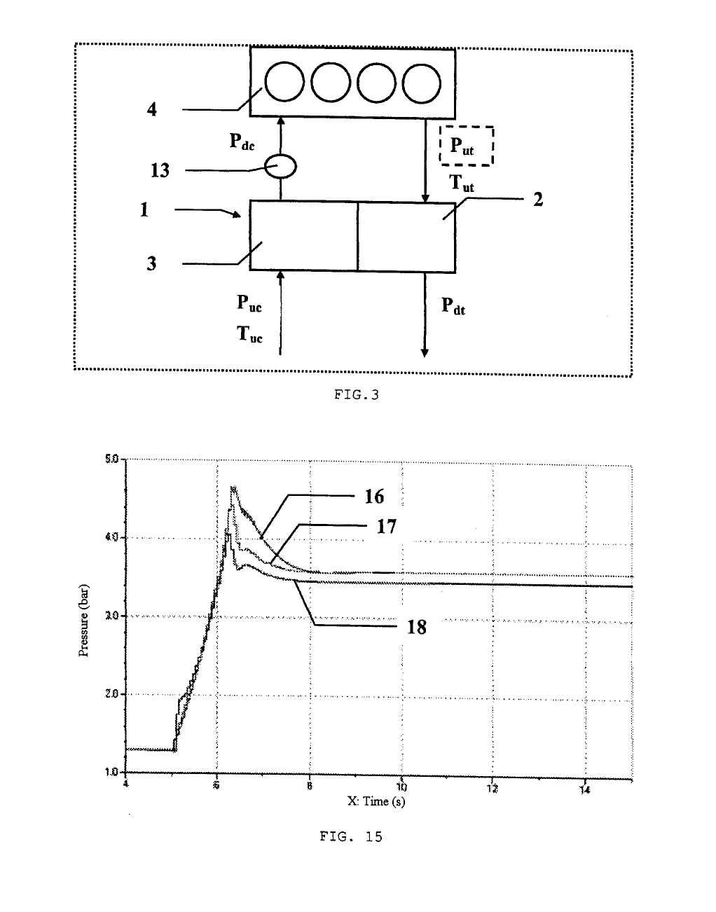

FIG. 3 is a diagram showing the input and output variables of the method,

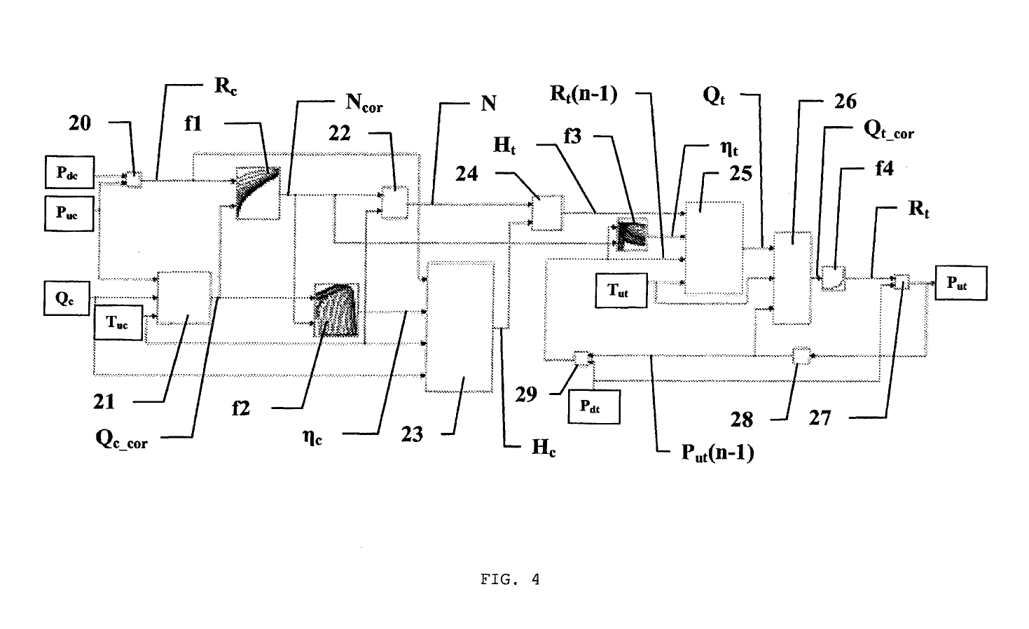

FIG. 4 is a block diagram of a first embodiment of the method according to the invention,

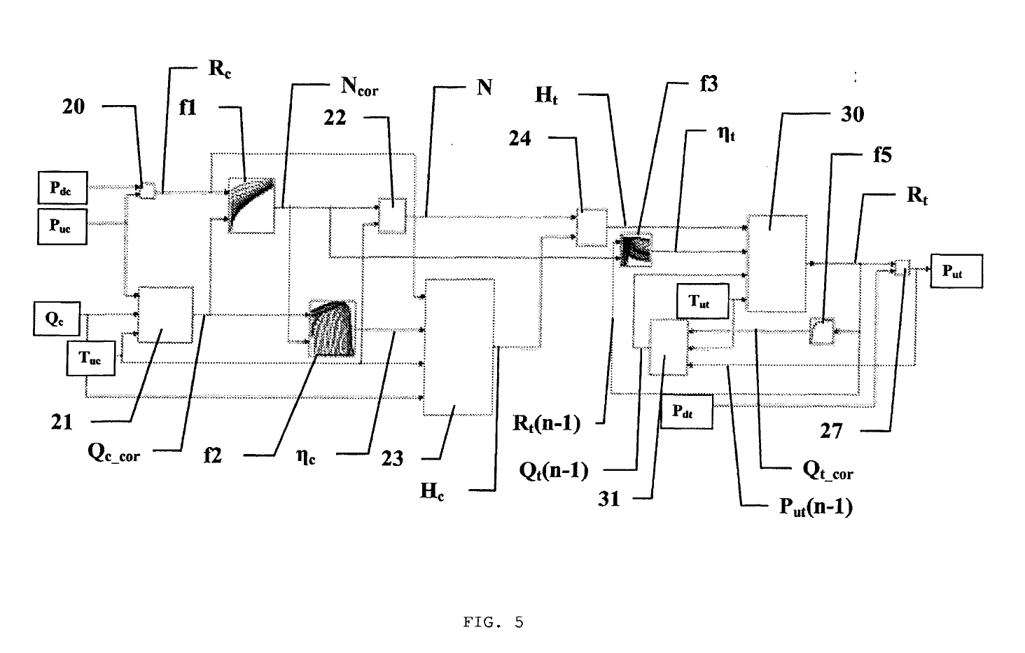

FIG. 5 is a block diagram of a second embodiment of the method according to the invention,

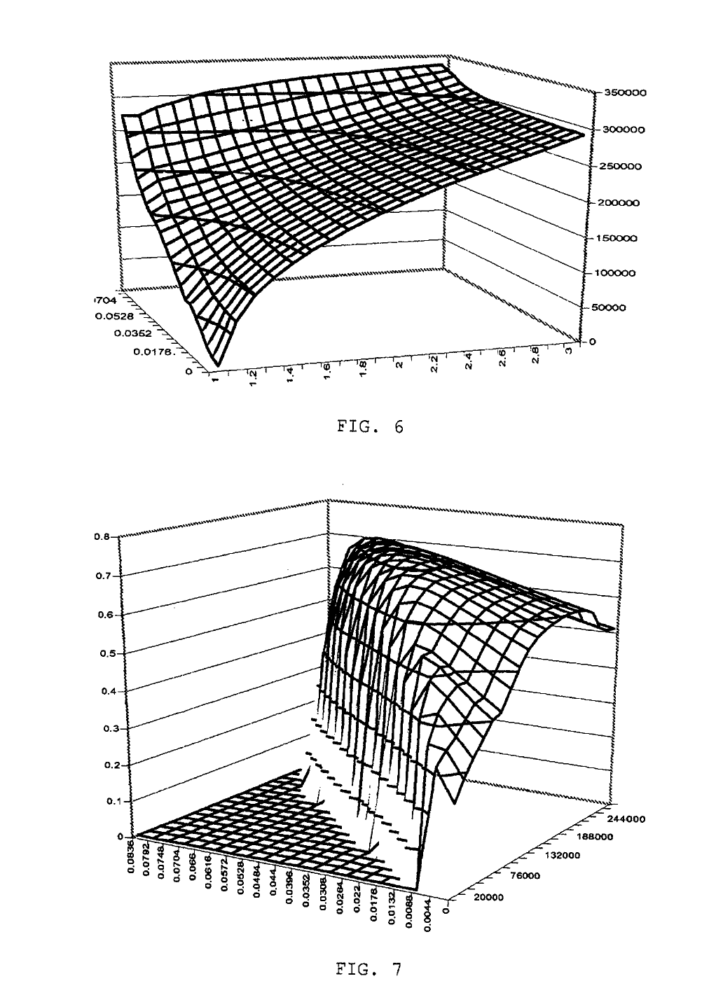

FIGS. 6-10 are respective maps of the functions f1, f2, f3, f4 and f5,

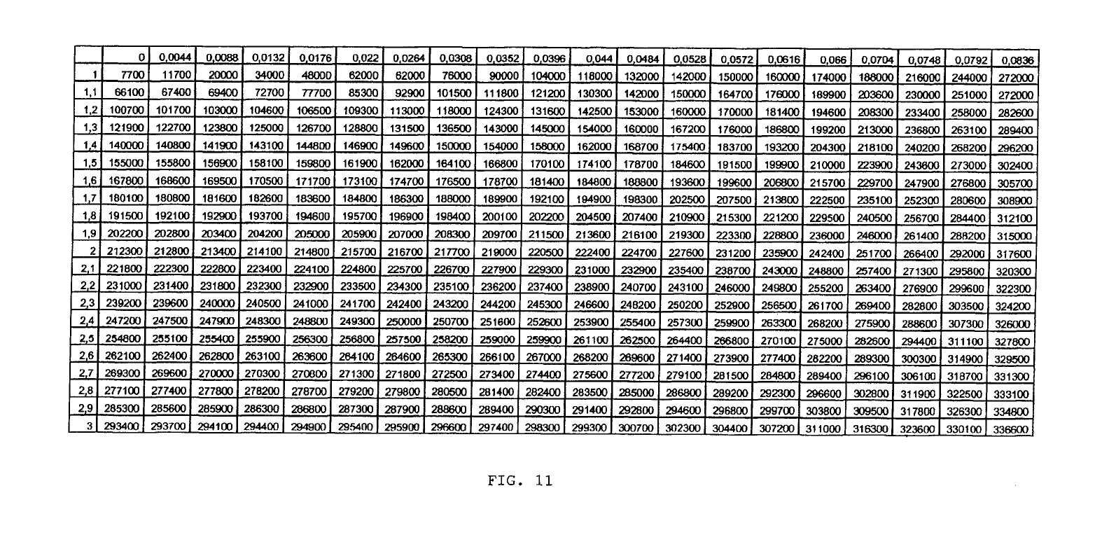

FIGS. 11-14 give respective numerical definitions of the functions f1-f4, and

FIG. 15 illustrates the quality of the result produced by the method.

In order to make the description, the block diagrams and the formulae in particular easier to understand, use is made of the following notation:

### Variables:

N: speed or rotational speed (of the turbocharger),
R: pressure ratio (compression ratio for the compressor, expansion ratio for the turbine),
Q: flow rate,
P: pressure,
H: power,
T: temperature,
η: efficiency,
Cp: thermodynamic constant—specific heat capacity at constant pressure,
Cv: thermodynamic constant—specific heat capacity at constant volume,
γ: thermodynamic constant—a coefficient equal to Cp/Cv,
J: moment of inertia (of the turbocharger).

### Suffixes:

c: compressor,
t: turbine,
cor: corrected parameter,
ref: reference parameter,
u: upstream,
d: downstream,
n: time suffix, current calculation step,
n−1: preceding current calculation step.

FIG. 1 illustrates the context of the invention. A combustion engine 4 conventionally receives air 5 via inlet tracts 6. The engine 4 produces exhaust gases 7 which are exhausted via exhaust tracts 8. A supercharging turbocharger 1 makes it possible to increase the amount of air 5 admitted by the combustion engine 4. To achieve that, the turbocharger 1 comprises a turbine 2 and a compressor 3. The turbine 2 is fluidically connected to the exhaust tracts 8 so as to be driven by the exhaust gases 7 leaving the combustion engine 4. The turbine 2 is mechanically secured to the compressor 3 the rotation of which it drives. The compressor 3 is fluidically connected to the inlet tracts 6 so that the compressor 3 compresses the intake air 5 before it enters the combustion engine 4. It is possible to isolate the turbine 2 using a bypass valve 11. It is possible to isolate the compressor using a bypass valve 10. Reference 9 identifies an intake air 5 flow rate sensor.

The diagram of FIG. 3 illustrates the same environment and shows the system variables. The turbocharger 1 is connected to the engine 4. The turbine 2 is arranged on the exhaust side 8. The compressor 3 is arranged on the intake side 6.

The stated problem assumes that it is desirable to estimate the pressure Pᵤₜ upstream of the turbine 2, drawn with a box round it in FIG. 3. It is assumed that the following parameters are known: flow rate Q_{c} (not depicted) of intake air passing through the compressor 3, the pressure P_{uc} upstream of the compressor 3, the temperature T_{uc} upstream of the compressor 3, the pressure P_{dc} downstream of the compressor 3, the temperature Tᵤₜ upstream of the turbine 2 and the pressure P_{dt} downstream of the turbine 2.

Knowledge of this pressure Pᵤₜ upstream of the turbine 2 is of key importance to fine-control of said turbocharger 1 in order to prevent damage thereto and reduce sluggishness of the vehicle during transients. However, it is not desirable to have to resort to a pressure sensor. The subject of the invention is therefore a method of estimating this pressure as a function of the other six parameters which are known from elsewhere.

FIG. 2 illustrates one special form of usage. Here, a second turbocharger 15 is added in series. Supercharging is then achieved by a staged double turbocharger. The second turbocharger 15 carries out a first compression of the intake air 5. It is also known as the low-pressure turbocharger. The first turbocharger 1 then carries out a second compression of the intake air exiting the compressor of the low-pressure turbocharger 15. The first turbocharger 1 is also known as the high-pressure turbocharger 1. A bypass valve 12 allows the low-pressure turbine to be isolated. The invention applies particularly to the case of the high-pressure turbocharger 1. The method is particularly well suited to a fixed-geometry turbocharger.

In this particular configuration, the six input parameters of the method according to the invention are advantageously determined by means of sensors for the flow rate Q_{c} of intake air passing through the compressor 3, the pressure P_{dc} downstream of the compressor 3 and the temperature Tᵤₜ upstream of the turbine 2, while the pressure P_{uc} upstream of the compressor 3, the temperature T_{uc} upstream of the compressor 3 and the pressure P_{dt} downstream of the turbine 2 are determined by an estimator that determines the parameters of the low-pressure turbocharger 15.

As may be seen in FIG. 2, the pressure P_{dt} downstream of the high-pressure turbine 2 is equal to the pressure upstream of the low-pressure turbine.

It may be necessary to cool the intake air 5. The choice has been made to use just one single heat exchanger 13, where appropriate, positioned downstream of the compressor 3. Thus, the absence of any heat exchanger in the inlet tract 6 between the low-pressure compressor and the high-pressure compressor 3 means that the temperature T_{uc} upstream of the high-pressure compressor 3 is known because it is equal to the temperature downstream of the low-pressure compressor.

The principle of the method according to the invention is illustrated for two embodiments by the block diagrams of FIGS. 4 and 5.

The method of determining the pressure Pᵤₜ upstream of the turbine 2 can be arbitrarily broken down into the following six steps:

1) calculating the corrected speed N_{cor} of the turbocharger 1 as a function of the compression ratio R_{c} of the compressor 3 and of the corrected flow rate Q_{c}_{_{—}}_{cor} of intake air passing through the compressor 3,
2) calculating the speed N of the turbocharger 1 as a function of the corrected speed N_{cor} of the turbocharger 1 and of the temperature T_{uc} upstream of the compressor 3,
3) calculating the power H_{c} of the compressor 3 as a function of the flow rate Q_{c} of intake air passing through the compressor 3, of the efficiency η_{c} of the compressor 3, of the temperature T_{uc} upstream of the compressor 3 and of the compression ratio R_{c} of the compressor 3,
4) calculating the power Hₜ of the turbine 2 as a function of the speed N of the turbocharger 1 and of the power H_{c} of the compressor 3,
5) calculating the expansion ratio Rₜ of the turbine 2,
6) calculating the pressure Pᵤₜ upstream of the turbine 2 as a function of the pressure P_{dt} downstream of the turbine 2 and of the expansion ratio Rₜ of the turbine 2.

It should be noted that steps 1-4 and 6 are identical in both embodiments. Only step 5 differentiates them.

In step 1) the corrected speed N_{cor} of the turbocharger 1 is calculated, as a function of the compression ratio R_{c} of the compressor 3 and of the corrected flow rate Q_{c}_{_{—}}_{cor} of intake air passing through the compressor 3, using a function f1. This function f1 of the compression ratio R_{c} of the compressor 3 and of the corrected flow rate Q_{c}_{_{—}}_{cor} of intake air passing through the compressor 3 is calculated in block f1. This function f1 is defined by a two-dimensional map.

A map is a known means for defining a function f. Said function f is defined graphically by a curve (one-dimensional map) or a surface (two-dimensional map). In the known and conventional way, the result z of the function f(x)=z (one-dimensional) or f(x,y)=z (two-dimensional) is determined graphically from the data point on the curve or on the surface. This same function f may alternatively, in an equivalent manner, be defined by a (one-dimensional or two-dimensional) table of numbers.

Thus, the function f1 is, for example, defined by the surface of FIG. 6 or, in an equivalent way, by a two-dimensional table of numbers. Thus, the function f1 is perfectly defined by the table of FIG. 11 where x can be read in the first column, y in the first row and the result z at the intersection of the row x and the column y. In the known way, the result is determined by interpolation when the x or y values are not directly present in the table.

The various maps of functions f1-f5 are thus determined for a compressor 3 and a turbine 2 both given by way of illustration and depicted respectively in FIGS. 6-10. If applied to a turbine 2 or to a compressor 3 that differ from those considered here, the person skilled in the art knows how to determine the maps for the functions f1-f5 either directly or by adapting (scaling, changing units, etc.) the operating maps supplied by the manufacturers of these rotary machines 2, 3.

The compression ratio R_{c} of the compressor 3 is, by definition, equal to the ratio of the pressure P_{uc} upstream of the compressor 3 to the pressure P_{dc} downstream of the compressor 3 and is calculated in block 20.

The corrected flow rate Q_{c}_{_{—}}_{cor} for intake air entering the compressor 3 is calculated using the formula:

$${Q}_{c\_cor} = \frac{\sqrt{\frac{{T}_{uc}}{{T}_{c\_ref}}}}{\frac{{P}_{uc}}{{P}_{c\_ref}}} ,$$

in which
Q_{c}_{_{—}}_{cor} is the corrected flow rate of intake air 5 passing through the compressor 3,
T_{uc} is the temperature upstream of the compressor 3,
P_{uc} is the pressure upstream of the compressor 3,
T_{c}_{_{—}}_{ref} is a reference temperature of the compressor 3,
P_{c}_{_{—}}_{ref} is a reference pressure of the compressor 3.

This formula is implemented in block 21.

The reference temperature T_{c}_{_{—}}_{ref} and reference pressure P_{c}_{_{—}}_{ref} are defined in such a way as to allow simplified calculation of the various mapped functions f1-f5 by always referring back to reference conditions so as to allow a single map to be used for each function f1-f5. The reference temperatures and pressures are, in the illustrative examples provided, equal to:

T_{c}_{_{—}}_{ref}=298K, Tₜ_{_{—}}_{ref}=873K, P_{c}_{_{—}}_{ref}=Pₜ_{_{—}}_{ref}=1 atm.

In step 2) the speed N of the turbocharger 1 is calculated using the formula:

$$N = {N}_{cor} \sqrt{\frac{{T}_{uc}}{{T}_{c\_ref}}} ,$$

in which
N is the speed of the turbocharger 1,
N_{cor} is the corrected speed of the turbocharger 1,
T_{uc} is the temperature upstream of the compressor 3,
T_{c}_{_{—}}_{ref} is the reference temperature of the compressor 3, described previously.

This formula is implemented in block 22.

In step 3) the power H_{c} of the compressor 3 is calculated using the formula:

$${H}_{c} = {Q}_{c} {Cp}_{c} \frac{1}{{η}_{c}} {T}_{uc} ( {R}_{c}^{\frac{{γ}_{c} - 1}{{γ}_{c}}} - 1 ) ,$$

in
which
H_{c} is the power of the compressor 3,
Q_{c} is the flow rate of intake air passing through the compressor 3,
η_{c} is the efficiency of the compressor 3,
T_{uc} is the temperature upstream of the compressor 3,
R_{c} is the compression ratio of the compressor 3,
Cp_{c} is a first thermodynamic constant of the intake air,
γ_{c} is a second thermodynamic constant of the intake air.

This formula is implemented in block 23.

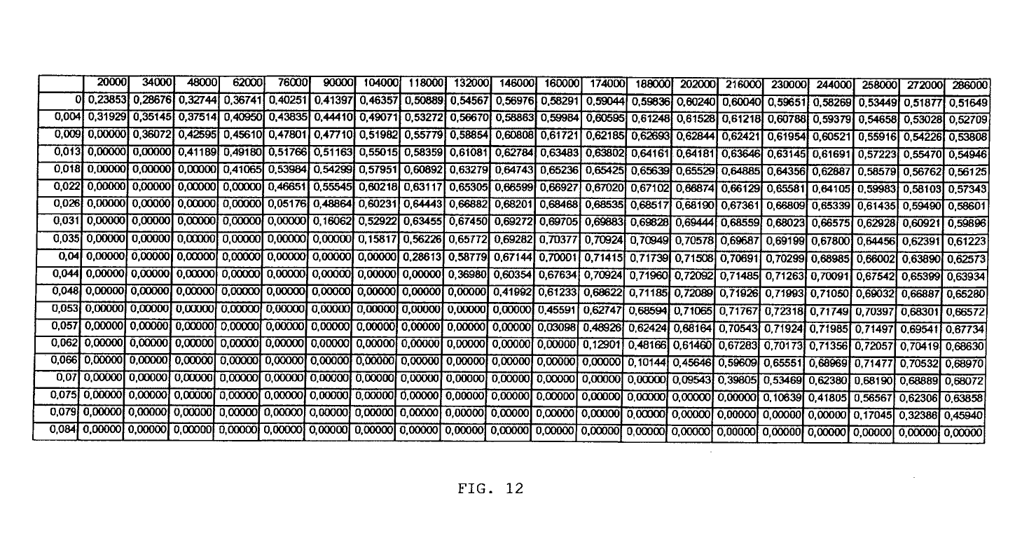

The efficiency η_{c} of the compressor 3, which is an input in said step 3), is calculated as a function of the corrected speed N_{cor} of the turbocharger 1 and of the corrected flow rate Q_{c}_{_{—}}_{cor} of intake air passing through the compressor 3, using a function f2 of the corrected speed N_{cor} of the turbocharger 1 and of the corrected flow rate Q_{c}_{_{—}}_{cor} of intake air passing through the compressor 3, this function being performed in block f2. Said function f2 is defined by a two-dimensional map. FIG. 7 illustrates the map of the function f2. The function f2 is also defined by the table of FIG. 12.

In the preceding formula, the first thermodynamic constant Cp_{c} for the intake air 5 is the specific heat capacity of the intake air 5 at constant pressure and is equal to 1005 J/kg/K, and the second thermodynamic constant γ_{c} for the intake air 5 is the coefficient Cp_{c}/Cv_{c} representing the ratio of the specific heat capacities of the intake air 5 at constant pressure and at constant volume respectively, and is equal to 1.4.

In step 4) the power Hₜ of the turbine 2 is then calculated using the formula:

$${H}_{t} = JN \frac{d N}{d t} - {H}_{c} ,$$

in which
Hₜ is the power of the turbine 2,
H_{c} is the power of the compressor 3,
N is the speed of the turbocharger 1,

$$\frac{d}{d t}$$

is the operator for differentiating with respect to the time variable, and
J is a constant equal to the moment of inertia of the turbocharger 1.

This formula, which is derived from the fundamental relationship of dynamics, is implemented in block 24.

Step 5) has the purpose of calculating the expansion ratio Rₜ of the turbine 2. Here, two ways of performing this step 5) are proposed, these respectively leading to the block diagrams of FIGS. 4 and 5.

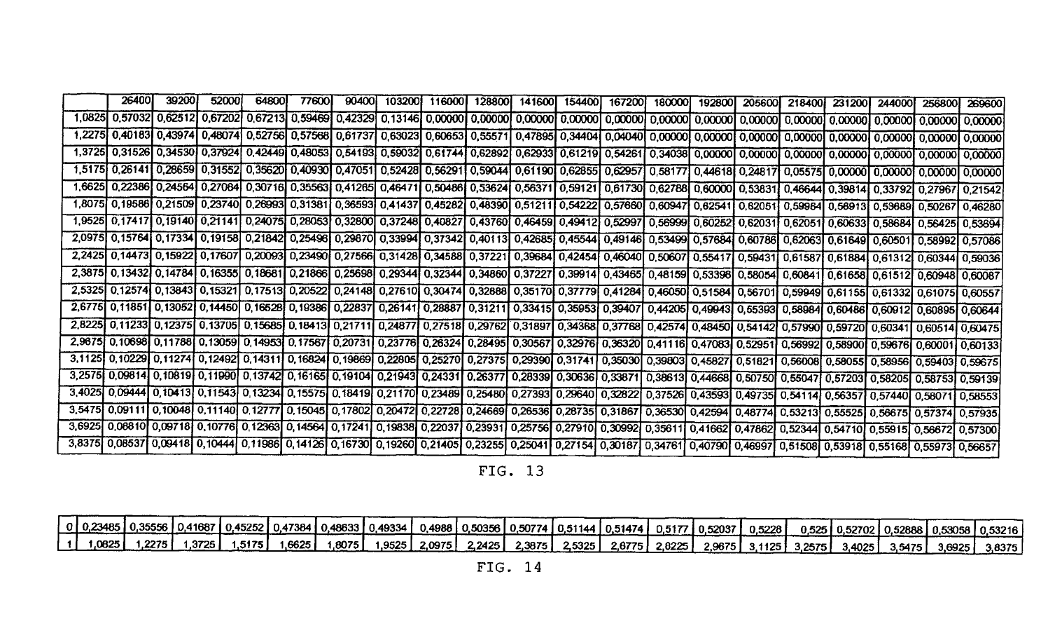

According to a first embodiment illustrated in the block diagram of FIG. 4, the expansion ratio Rₜ of the turbine 2 is calculated as a function of the corrected flow rate Q_{c}_{_{—}}_{cor} of exhaust gas 7 passing through the turbine 2 using a function f4 of the corrected flow rate Qₜ of the exhaust gas 7 passing through the turbine 2, performed in block f4. This function f4 is defined by a one-dimensional map. FIG. 9 illustrates the map of the function f4. The function f4 is also defined by the table of FIG. 14.

This corrected flow rate Qₜ_{_{—}}_{cor} of exhaust gas 7 passing through the turbine 2 is calculated using the formula:

$${Q}_{t\_cor} = {Q}_{t} \frac{\sqrt{{T}_{ut}}}{{P}_{ut} ( n - 1 )} ,$$

in which
Qₜ_{_{—}}_{cor} is the corrected flow rate of exhaust gas 7 passing through the turbine 2,
Qₜ is the flow rate of exhaust gas 7 passing through the turbine 2,
Tᵤₜ is the temperature upstream of the turbine 2,
Pᵤₜ is the pressure upstream of the turbine 2, the suffix n−1 indicating here that it is determined in the time interval n−1 preceding the current time interval n.

This formula is implemented in block 26.

The flow rate Qₜ of exhaust gas 7 passing through the turbine 2 is calculated using the formula:

$${Q}_{t} = \frac{{H}_{t}}{{Cp}_{t} {η}_{t} {T}_{ut} ( 1 - {( \frac{1}{{R}_{t} ( n - 1 )} )}^{\frac{{γ}_{t} - 1}{{γ}_{t}}} )} ,$$

in which
Qₜ is the flow rate of exhaust gas 7 passing through the turbine 2,
Hₜ is the power of the turbine 2,
ηₜ is the efficiency of the turbine 2,
Tᵤₜ is the temperature upstream of the turbine 2,
Rₜ is the expansion ratio of the turbine 2, the suffix
n−1 indicating here that it is determined in the preceding time interval n−1,
Cpₜ is a first thermodynamic constant of the exhaust gas 7,
γₜ is a second thermodynamic constant of the exhaust gas 7.

Block 28 is a 1/z delay block allowing storage of the value Pᵤₜ(n−1) of the parameter Pᵤₜ from the preceding time interval n−1.

Block 29 is a multiplying block allowing calculation of Rₜ (n−1) by multiplying Pᵤₜ (n−1) by P_{dt}.

According to a second embodiment illustrated in the block diagram of FIG. 5, the expansion ratio Rₜ of the turbine 2 is calculated as a function of the power Hₜ of the turbine 2, of the flow rate Qₜ of exhaust gas 7 passing through the turbine 2, of the efficiency ηₜ of the turbine 2, of the temperature Tᵤₜ upstream of the turbine 2, using the formula:

$${R}_{t} = {( 1 - \frac{{H}_{t}}{{Q}_{t} ( n - 1 ) {cp}_{t} {η}_{t} {T}_{ut}} )}^{\frac{- {γ}_{t}}{{γ}_{i} - 1}} ,$$

in which
Rₜ is the expansion ratio of the turbine 2,
Hₜ is the power of the turbine 2,
Qₜ is the flow rate of exhaust gas 7 passing through the turbine 2, the suffix n−1 indicating here that it is determined in the preceding time interval n−1,
ηₜ is the efficiency of the turbine 2,
Tᵤₜ is the temperature upstream of the turbine 2,
Cpₜ is a first thermodynamic constant of the exhaust gas 7,
γₜ is a second thermodynamic constant of the exhaust gas 7.

This formula is implemented in block 30.

The flow rate Qₜ of exhaust gas 7 passing through the turbine 2 is calculated as a function of the corrected flow rate Qₜ_{_{—}}_{cor} of exhaust gas 7 passing through the turbine 2, using the formula:

$${Q}_{t} ( n - 1 ) = {Q}_{t\_cor} \frac{{P}_{ut} ( n - 1 )}{\sqrt{{T}_{ut}}} ,$$

in which
Qₜ is the flow rate of exhaust gas 7 passing through the turbine 2, the suffix n−1 indicating here that it is determined in the preceding time interval n−1,
Qₜ_{_{—}}_{cor} is the corrected flow rate of exhaust gas 7 passing through the turbine 2,
Pᵤₜ is the pressure upstream of the turbine 2, the suffix n−1 indicating here that it is determined in the preceding time interval n−1, and
Tᵤₜ is the temperature upstream of the turbine 2.

This formula is implemented in block 31.

The corrected flow rate Qₜ_{_{—}}_{cor} of exhaust gas 7 passing through the turbine 2 is calculated as a function of the expansion ratio Rₜ of the turbine 2 by means of a function f5 of the expansion ratio Rₜ of the turbine 2. This function is carried out in block f5. Said function f5 is defined by a one-dimensional map. FIG. 10 illustrates the map of the function f5. The function f5 is the inverse function of the function f4. The function f5 is also defined by the table of FIG. 14.

In the preceding formulae in blocks 25 and 31, the first thermodynamic constant Cpₜ of the exhaust gas 7 is the specific heat capacity of the exhaust gas 7 at constant pressure and is equal to 1136 J/kg/K, and the second thermodynamic constant γₜ of the exhaust gas 7 is the coefficient Cpₜ/Cvₜ that is the ratio of the specific heat capacities of the exhaust gas 7 at constant pressure and at constant volume respectively and is equal to 1.34.

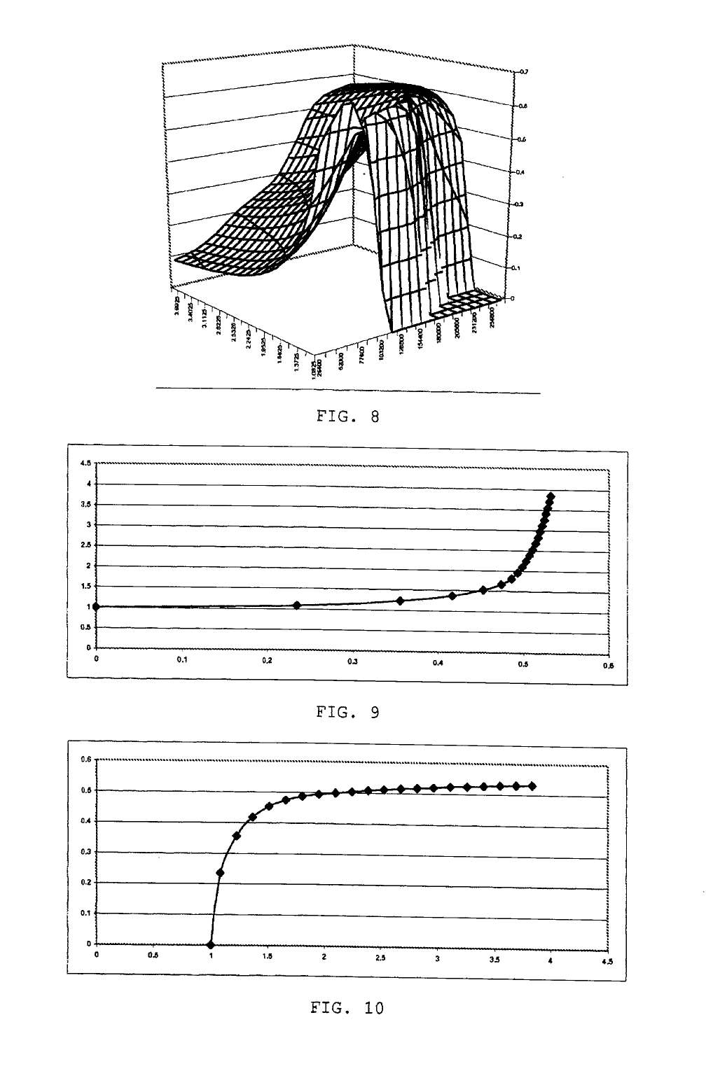

The two alternative forms of step 5) according to the two embodiments require the efficiency ηₜ of the turbine 2 to be determined. This efficiency is calculated as a function of the corrected speed N_{cor} of the turbocharger 1 and of the expansion ratio Rₜ(n−1) of the turbine 2 determined in the preceding time interval n−1, using a function f3 of the corrected speed N_{cor} of the turbo-charger 1 and of the expansion ratio Rₜ of the turbine 2, carried out in block f3. Said function f3 is defined by a two-dimensional map. FIG. 8 illustrates the map of the function f3. The function f3 is also defined by the table of FIG. 13.

The final step 6) calculates the result, namely the pressure Pᵤₜ upstream of the turbine 2, using the formula: Pᵤₜ=P_{dt}Rₜ, derived from the definition of Rₜ, in which

Pᵤₜ is the pressure upstream of the turbine 2,
P_{dt} is the pressure downstream of the turbine 2, and
Rₜ is the expansion ratio of the turbine 2, previously determined in step 5).

This formula is carried out in the multiplication block 27.

The invention also relates to an estimator produced using a logic, mechanical, electronic, or hydraulic device or alternatively using a controller and its software program, capable of implementing the method according to one of the embodiments described hereinabove.

FIG. 12 gives, for comparison, the results obtained by the method or the estimator according to the invention. The pressure Pᵤₜ upstream of the turbine 2 as a function of time is depicted on one single axes system for one same event (a transient at 2000 rpm). Curve 16 shows the result obtained with the first embodiment. Curve 17 shows the result obtained with the second embodiment. The result is very satisfactory when compared against a reference curve 18.

1-19. (canceled)

20. A method for determining, for a turbocharger that supercharges a combustion engine including a turbine driven by exhaust gases exiting the combustion engine and mechanically rotating as one with a compressor so as to compress intake air injected into the combustion engine, pressure upstream of the turbine as a function of flow rate of intake air through the compressor, pressure upstream of the compressor, temperature upstream of the compressor, pressure downstream of the compressor, temperature upstream of the turbine, and pressure downstream of the turbine, the method comprising:
calculating a corrected speed of the turbocharger as a function of compression ratio of the compressor and of corrected flow rate of intake air passing through the compressor;
calculating speed of the turbocharger as a function of the corrected speed of the turbocharger and of the temperature upstream of the compressor;
calculating power of the compressor as a function of the flow rate of intake air passing through the compressor, of efficiency of the compressor, of the temperature upstream of the compressor, and of the compression ratio of the compressor;
calculating power of the turbine as a function of the speed of the turbocharger and of power of the compressor;
calculating an expansion ratio of the turbine; and
calculating pressure upstream of the turbine as a function of the pressure downstream of the turbine and of the expansion ratio of the turbine.

21. The method as claimed in claim 20, in which the corrected flow rate of intake air of the compressor is calculated using the formula:
$${Q}_{c\_cor} = \frac{\sqrt{\frac{{T}_{uc}}{{T}_{c\_ref}}}}{\frac{{P}_{uc}}{{P}_{c\_ref}}} ,$$
in which
Q_{c}_{_{—}}_{cor} is the corrected flow rate of intake air passing through the compressor,
T_{uc} is the temperature upstream of the compressor,
P_{uc} is the pressure upstream of the compressor,
T_{c}_{_{—}}_{ref} is a reference temperature of the compressor,
P_{c}_{_{—}}_{ref} is a reference pressure of the compressor.

22. The method as claimed in claim 20, in which the corrected speed of the turbocharger is calculated as a function of the compression ratio of the compressor and of the corrected flow rate of intake air passing through the compressor, using a function of the compression ratio of the compressor and of the corrected flow rate of intake air passing through the compressor, the function being defined by a two-dimensional map.

23. The method as claimed in claim 20, in which the speed of the turbocharger is calculated using the formula:
$$N = {N}_{cor} \sqrt{\frac{{T}_{uc}}{{T}_{c\_ref}}} ,$$
in which
N is the speed of the turbocharger,
N_{cor} is the corrected speed of the turbocharger,
T_{uc} is the temperature upstream of the compressor,
T_{c}_{_{—}}_{ref} is a reference temperature of the compressor.

24. The method as claimed in claim 20, in which the power of the compressor is calculated using the formula:
$${H}_{c} = {Q}_{c} {Cp}_{c} \frac{1}{{η}_{c}} {T}_{uc} ( {R}^{\frac{{γ}_{c} - 1}{{γ}_{c}}} - 1 ) ,$$
in which
H_{c} is the power of the compressor,
Q_{c} is the flow rate of intake air passing through the compressor,
η_{c} is the efficiency of the compressor,
T_{uc} is the temperature upstream of the compressor,
R_{c} is the compression ratio of the compressor,
Cp_{c} is a first thermodynamic constant of the intake air,
γ_{c} is a second thermodynamic constant of the intake air.

25. The method as claimed in claim 24, in which the efficiency of the compressor is calculated as a function of the corrected speed of the turbocharger and of the corrected flow rate of intake air passing through the compressor, using a function of the corrected speed of the turbocharger and of the corrected flow rate of intake air passing through the compressor, the function being defined by a two-dimensional map.

26. The method as claimed in claim 24, in which the first thermodynamic constant of the intake air is equal to 1005 J/kg/K, and in which the second thermodynamic constant of the intake air is equal to 1.4.

27. The method as claimed in claim 20, in which the power of the turbine is calculated using the formula:
$${H}_{t} = JN \frac{d N}{d t} - {H}_{c} ,$$
in which
Hₜ is the power of the turbine,
H_{c} is the power of the compressor,
N is the speed of the turbocharger,
$$\frac{d}{d t}$$
is the operator for differentiating with respect to the time variable, and
J is a constant equal to the moment of inertia of the turbocharger.

28. The method as claimed in claim 20, in which the expansion ratio of the turbine is calculated as a function of the corrected flow rate of exhaust gas passing through the turbine using a function of the corrected flow rate of exhaust gas passing through the turbine, the function being defined by a one-dimensional map.

29. The method as claimed in claim 28, in which the corrected flow rate of exhaust gas passing through the turbine is calculated using the formula:
$${Q}_{t\_cor} = {Q}_{t} \frac{\sqrt{{T}_{ut}}}{{p}_{ut} ( n - 1 )} ,$$
in which
Qₜ_{_{—}}_{cor} is the corrected flow rate of exhaust gas passing through the turbine,
Qₜ is the flow rate of exhaust gas passing through the turbine,
Tᵤₜ is the temperature upstream of the turbine,
Pᵤₜ is the pressure upstream of the turbine, the suffix indicating here that it is determined in the preceding time interval.

30. The method as claimed in claim 29, in which the flow rate of exhaust gas passing through the turbine is calculated using the formula:
$${Q}_{t} = \frac{{H}_{t}}{{Cp}_{t} {η}_{t} {T}_{ut} ( 1 - {( \frac{1}{{R}_{t} ( n - 1 )} )}^{\frac{{γ}_{t} - 1}{{γ}_{t}}} )} ,$$
in which
Qₜ is the flow rate of exhaust gas passing through the turbine,
Hₜ is the power of the turbine,
ηₜ is the efficiency of the turbine,
Tᵤₜ is the temperature upstream of the turbine,
Rₜ is the expansion ratio of the turbine, the suffix indicating here that it is determined in the preceding time interval,
Cpₜ is a first thermodynamic constant of the exhaust gas,
γₜ is a second thermodynamic constant of the exhaust gas.

31. The method as claimed in claim 20, in which the expansion ratio of the turbine is calculated as a function of the power of the turbine, of the flow rate of exhaust gas passing through the turbine, of the efficiency of the turbine, of the temperature upstream of the turbine, using the formula:
$${R}_{t} = {( 1 - \frac{{H}_{t}}{{Q}_{t} ( n - 1 ) {Cp}_{t} {η}_{t} {T}_{ut}} )}^{\frac{- {γ}_{t}}{{γ}_{i} - 1}} ,$$
in which
Rₜ is the expansion ratio of the turbine,
Hₜ is the power of the turbine,
Qₜ is the flow rate of exhaust gas passing through the turbine, the suffix indicating here that it is determined in the preceding time interval,
ηₜ is the efficiency of the turbine,
Tᵤₜ is the temperature upstream of the turbine,
Cpₜ is a first thermodynamic constant of the exhaust gas,
γₜ is a second thermodynamic constant of the exhaust gas.

32. The method as claimed in claim 31, in which the flow rate of exhaust gas passing through the turbine is calculated as a function of the corrected flow rate of exhaust gas passing through the turbine, using the formula:
$${Q}_{t} ( n - 1 ) = {Q}_{t\_cor} \frac{{P}_{ut} ( n - 1 )}{\sqrt{{T}_{ut}}} ,$$
in which
Qₜ is the flow rate of exhaust gas passing through the turbine, the suffix indicating here that it is determined in the preceding time interval,
Qₜ_{_{—}}_{cor} is the corrected flow rate of exhaust gas passing through the turbine,
Pᵤₜ is the pressure upstream of the turbine, the suffix indicating here that it is determined in the preceding time interval, and
Tᵤₜ is the temperature upstream of the turbine.

33. The method as claimed in claim 32, in which the corrected flow rate of exhaust gas passing through the turbine is calculated as a function of the expansion ratio of the turbine using a function of the expansion ratio of the turbine, the function being defined by a one-dimensional map.

34. The method as claimed in claim 30, in which the first thermodynamic constant of the exhaust gas is equal to 1136 J/kg/K, and in which the second thermodynamic constant of the exhaust gas is equal to 1.34.

35. The method as claimed in claim 20, in which the efficiency of the turbine is calculated as a function of the corrected speed of the turbocharger and of the expansion ratio of the turbine determined in the preceding time interval, using a function of the corrected speed of the turbocharger and of the expansion ratio of the turbine, the function being defined by a two-dimensional map.

36. The method as claimed in claim 20, in which the pressure upstream of the turbine is calculated using the formula:
Pᵤₜ=P_{dt}Rₜ
in which
Pᵤₜ is the pressure upstream of the turbine,
P_{dt} is the pressure downstream of the turbine, and
R₁ is the expansion ratio of the turbine.

37. The method as claimed in claim 20, in which the flow rate of intake air passing through the compressor, the pressure downstream of the compressor, and the temperature upstream of the turbine are measured by sensors, and the pressure upstream of the compressor, the temperature upstream of the compressor, and the pressure downstream of the turbine are determined by an estimator.

38. A device capable of implementing the method as claimed in claim 20.
